(19) United States
(12) Patent Application Publication
(10) Pub. No.: US 2011/0149353 A1
(43) Pub. Date: Jun. 23, 2011

(54) CALIBRATION SURFACE AND PLATEN FOR AN IMAGE CAPTURE DEVICE

(76) Inventor: Peter Majewicz, Boise, ID (US)

(21) Appl. No.: 12/641,392

(22) Filed: Dec. 18, 2009

(51) Int. Cl. H04N 1/04; H04N 17/00

(52) U.S. Cl. 358/474; 348/187; 348/E17.001

(57) ABSTRACT

In one embodiment, a calibration surface for an image capture device includes a surface comprising glossy areas and matte areas. In another embodiment, a platen for supporting a document or other object to be imaged in an image capture device includes a flat surface having glossy areas and matte areas thereon. The surface may include, for example, a checkerboard or other pattern of alternating glossy white areas and matte white areas in which each glossy white area is surrounded by matte white areas and each matte white area is surrounded by glossy white areas.

### BACKGROUND

In a camera based document image capture device, the camera is aimed at a platen upon which documents are placed to be photographed. Such an image capture device typically uses one or more lamps to illuminate the document but may also use ambient light to illuminate the document. Light reflected off the document to the camera will be composed of specular and diffuse reflectance. Specular reflectance is a mirror-like reflection in which the inclination of the light reflected off the document is the same as the inclination of the light hitting the document (i.e., the incident and reflection angles have the same magnitude). Diffuse reflectance is a reflection in which the incident light is reflected through a wide range of angles (i.e., the incident light is scattered as it reflects off the document). Diffuse reflectance is usually associated with reflections off matte surfaces.

Specular reflectance may cause glare off glossy surfaces and wash out a document image. Thus, specular reflectance is undesirable for document image capture and particularly troublesome for photographing magazine pages and other documents that have high toner or ink coverage or have been printed on glossy media. Special camera exposure settings and image processing techniques are needed to accurately reproduce specular reflectance regions of a document. Knowing that glare is present as well as knowing its location, extent, and magnitude is important for establishing the appropriate camera settings and image processing techniques to distinguish between regions of a document that appear washed out due to the highlights or other content of the document and regions of specular reflectance washed out by glare.

### BRIEF DESCRIPTION OF THE DRAWINGS

FIGS. 1 and 2 are perspective and plan views, respectively, illustrating a calibration surface on a platen for supporting a document or other object to be imaged in an image capture device, according to one embodiment of the disclosure.

FIG. 3 is a plan view depicting the appearance of the calibration surface of FIGS. 1 and 2 when it is photographed while being illuminated to detect areas of specular reflectance and areas of diffuse reflectance.

FIGS. 4-6 and 7-9 show specular and diffuse reflectance image profiles, respectively, that may be created from image data in a photograph such as that depicted in FIG. 3.

FIG. 10 is a perspective view illustrating one embodiment of an image capture device using a calibration surface and platen such as that shown in FIGS. 1 and 2.

FIG. 11 is a perspective view illustrating another embodiment of an image capture device using a calibration surface and platen such as that shown in FIGS. 1 and 2.

FIG. 12 is a perspective view illustrating another embodiment of an image capture device using a calibration surface and platen such as that shown in FIGS. 1 and 2.

### DESCRIPTION

Embodiments of the present disclosure were developed in an effort to help distinguish between regions of a document that appear washed out due to the highlights or other content of the document and regions of specular reflectance washed out by glare so that appropriate subsequent actions can be taken to accurately capture an image of the document. Embodiments are described with reference to a platen for supporting a document or other object to be imaged in an image capture device. The surface of the platen may be used as a calibration surface, for example to create reflectance profiles that can be applied to images of documents or other objects to compensate for non-uniformities of specular and diffuse reflectance. Embodiments of the disclosure, however, are not limited to platens or platen surfaces but may be used for other types of calibration surfaces. The following description, therefore, should not be construed to limit the scope of the disclosure, which is defined in the claims that follow the description.

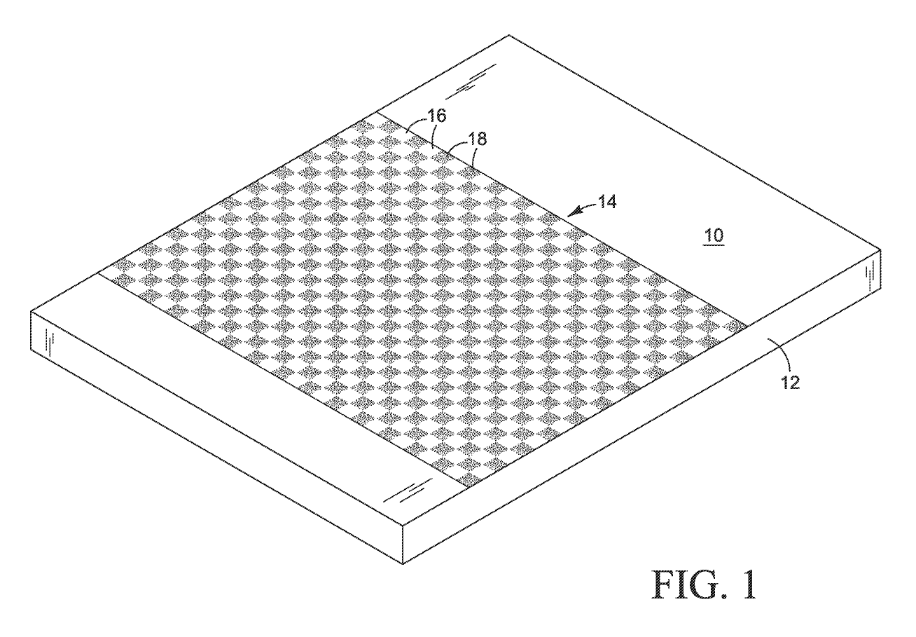

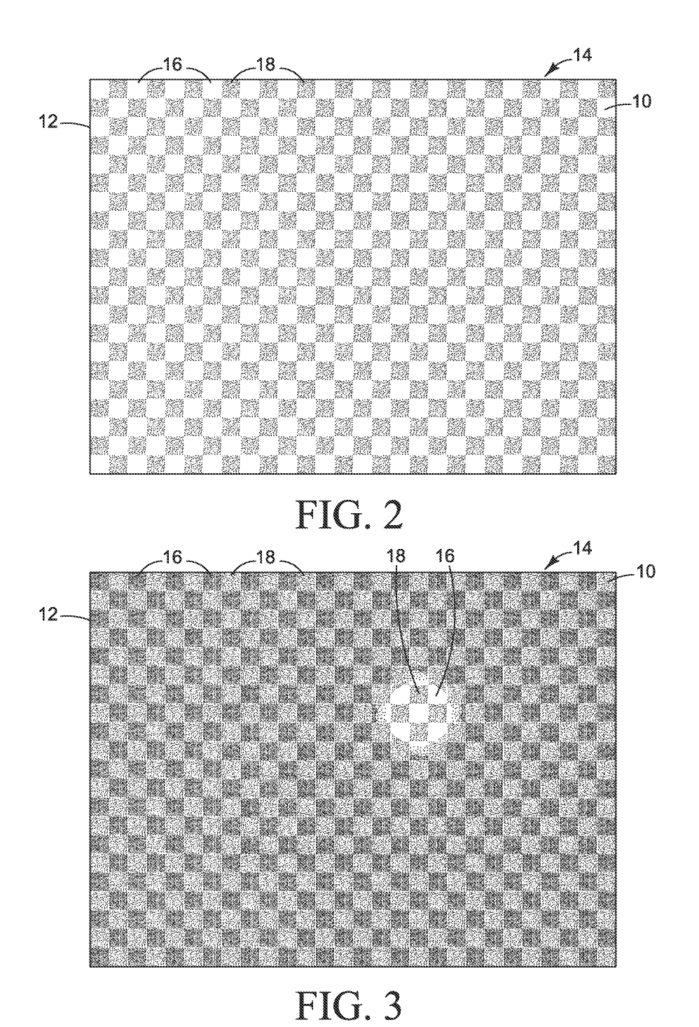

FIGS. 1 and 2 are perspective and plan views, respectively, illustrating one embodiment of a calibration surface 10 on a platen 12 that may be used, for example, for supporting a document or other object to be imaged in an image capture device. Referring to FIGS. 1 and 2, a flat calibration surface 10 includes a pattern 14 of glossy areas 16 and matte areas 18. In the embodiment shown, surface pattern 14 is a checkerboard pattern 14 of alternating white glossy areas 16 and white matte areas 18 in which each white glossy area 16 is surrounded by white matte areas 18 and each white matte area 18 is surrounded by white glossy areas 16. Glossy areas 16 respond strongly to specular light while matte areas 18 do not. This phenomenon is illustrated in FIG. 3. FIG. 3 is a plan view that depicts the appearance of surface 10 when it is photographed while being illuminated with a sharply focused LED (light emitting diode) to detect areas of specular reflectance and areas of diffuse reflectance. As shown in FIG. 3, the glossy areas 16 near the center of the illuminated area detect specular reflectance (white) while the matte areas 18 detect diffuse reflectance (light gray). The matte areas 18 are not affected by the glare “hotspot” at the center of the illuminated area. The predominately gray color of surface 10 in FIG. 3, which is depicted by overall gray stippling as best seen by comparing FIGS. 2 and 3, is a side effect of calibrating the camera so that it sees specular glare as pure white.

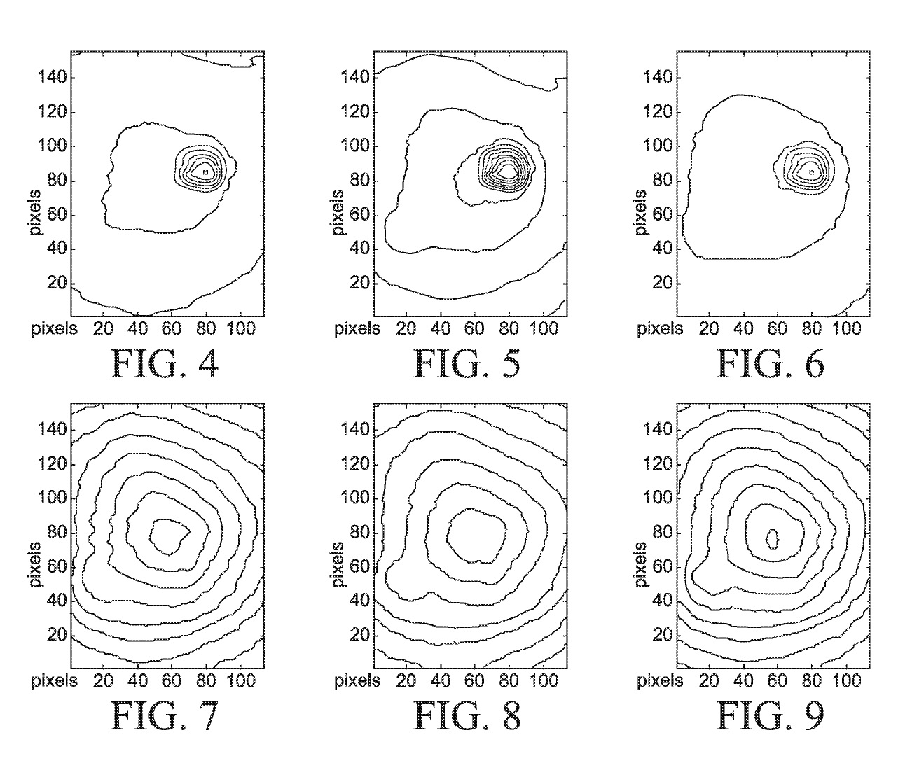

FIGS. 4-6 and 7-9 show specular and diffuse reflectance image profiles, respectively, that may be created from image data in a photograph such as that depicted in FIG. 3. FIGS. 4-6 show red (FIG. 4), green (FIG. 5) and blue (FIG. 6) color profiles associated with a specular reflectance image from FIG. 3. FIGS. 7-9 show red (FIG. 7), green (FIG. 8) and blue (FIG. 9) color profiles associated with a diffuse reflectance image from FIG. 3. These RGB color profiles can be used in detecting a glare condition, and in creating field uniformity calibration profiles that can be applied to images of documents or other objects to compensate for non-uniformities of specular and diffuse reflectance.

Referring again to FIGS. 1-2, while it is expected that a repeating pattern of alternating glossy and matte areas 16 and 18, a checkerboard pattern 14 for example, will yield appropriate results, other patterns may be used. Indeed, a calibration surface 10 may include random or other non-patterned distributions of glossy and matte areas 16, 18. The glossy and matte areas should be arranged over the calibration surface in such a way that changes to the reflectance image profiles may be discovered and characterized, which involves extracting the glossy and matte areas from the surface and interpolating between them to create data over the other type of area. Thus, one type of area needs the other type of area nearby and each area should not be too big to impede meaningful interpolation.

A checkerboard pattern 14 of 1 cm square areas 16, 18, for example, will be adequate to discover and characterize changes to the reflectance image profiles. A checkerboard pattern 14 provides a 50/50 ratio in the density of glossy areas 16 to matte areas 18. As may be seen by comparing the graphs of FIGS. 4-6 for specular reflectance with the graphs of FIGS. 7-9 for diffuse reflectance, specular reflectance changes more quickly across surface 10 than does diffuse reflectance. Consequently, it may be desirable in some implementations to increase the density of glossy areas, for example to a 70/30 ratio in the density of glossy areas 16 to matte areas 18. Also, the pattern 14 is not limited to a checkerboard pattern and the shape of the areas 16, 18 is not limited to squares. An arrangement of hexagonal shaped areas 16, 18, for another example, could be used. Also, although the glossy and matte areas 16, 18 need not be arranged in a pattern of periodic or repeating glossy and matte areas 16, 18, the arrangement of glossy and matte areas must be known. White is desirable for the color of glossy and matte areas 16, 18 on surface 10 because it allows for direct calculation of camera gain and exposure settings, and a darker colored surface 10 may show through lighter color documents when imaging such documents. Other suitably light colors might also be used for glossy and matte areas 16, 18. Also, the glossy and matte areas 16, 18 need not cover all of surface 10. For example, it may be useful in some implementations to include a different color background around and/or between glossy and matte areas 16, 18.

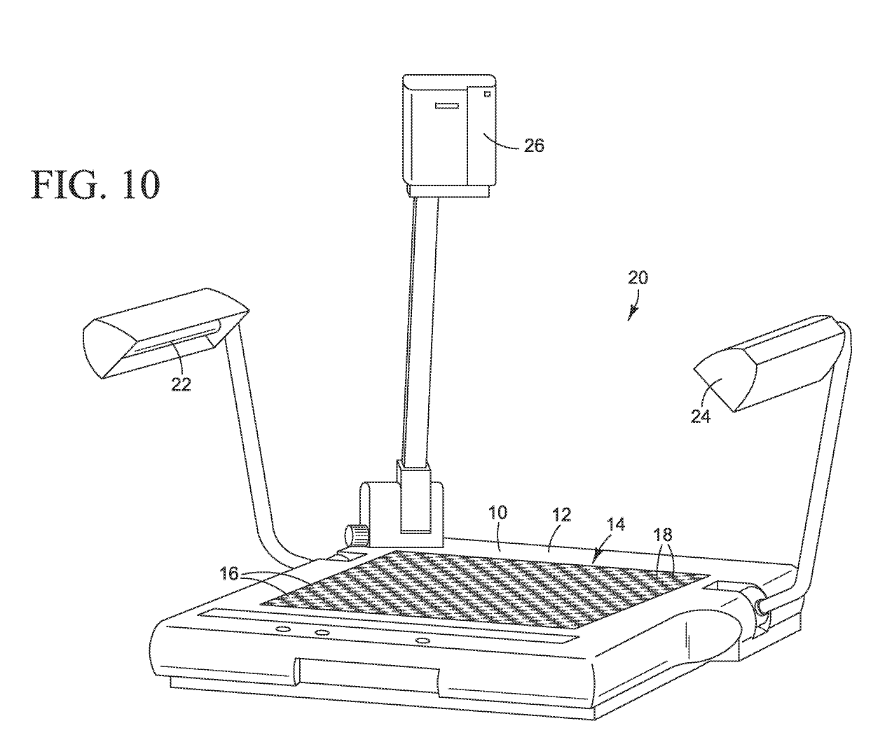

FIG. 10 is a perspective view illustrating an image capture device 20 using a calibration surface 10 and platen 12 such as that shown in FIGS. 1 and 2. Image capture device 20 in FIG. 10 represents a traditional arrangement in which surface 10 or a document or other object on surface 10 is illuminated by two diffuse fluorescent lamps 22 and 24 and photographed by a digital camera 26.

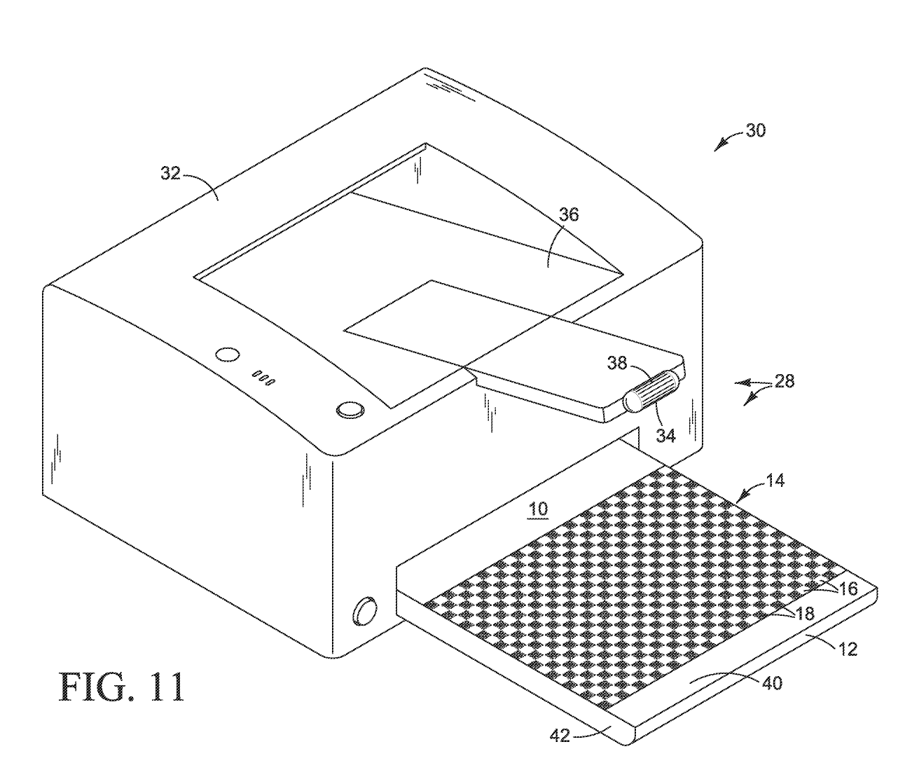

FIG. 11 is a perspective view illustrating another image capture device 28 using a calibration surface 10 and platen 12 such as that shown in FIGS. 1 and 2. Image capture device 28 in FIG. 11 represents a new, more compact embodiment integrated into a multi-function device 30 that also includes a printer 32. In the image capture device 28 shown in FIG. 11, surface 10 or a document or other object on surface 10 is illuminated by a small, sharply focused LED 34 mounted to the output tray 36 of printer 32 and photographed by a digital camera 38 that is also mounted to output tray 36. The cover 40 of the printer input tray 42 serves as the platen 12 for image capture device 28.

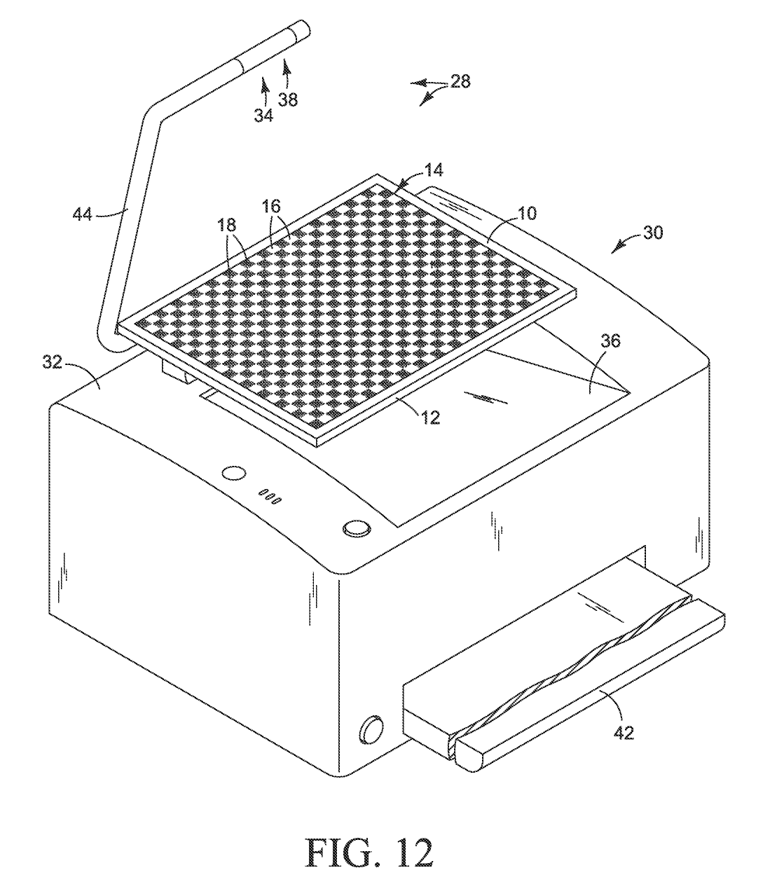

FIG. 12 is a perspective view illustrating another embodiment of an image capture device 28 integrated into a multi-function device 30 that also includes a printer 32. In the embodiment shown in FIG. 12, platen 12 with calibration surface 10 is mounted over the printer output tray 36. Surface 10 or a document or other object on surface 10 is illuminated by a small, sharply focused LED 34 and photographed by a digital camera 38 mounted to a hinged arm 44. Arm 44 is movable between an upright position such as that shown in FIG. 12 for imaging objects on surface 10 and a stowed position down, adjacent to platen 12.

Image capture device 28 in FIGS. 11 and 12 is more susceptible to glare than is device 20 in FIG. 10 because LED 34 is sharply focused on surface 10 and because the smaller, less powerful LED 34 is not able to completely overcome all glare from ambient light. Thus, device 28 in FIGS. 11 and 12 is likely to benefit more from a new calibration surface 10 than its more traditional counterpart 20.

Embodiments of the new calibration surface allow for generating specular and diffuse calibration profiles, making document capture with small LED lamps more robust against lamp and ambient glare. Glossy documents can be more successfully photographed and image capture devices will behave closer to the familiar flatbed or ADF scanners which do not suffer from glare. Embodiments of the new calibration surface and platen may also help enable lower cost, lamp-less devices. Since one purpose for a built-in lamp is to overcome ambient glare, and since embodiments of the new calibration surface can provide for active calibration to compensate for ambient glare, it may even be possible to rely solely on ambient light for successful image capture.

As noted at the beginning of this Description, the exemplary embodiments shown in the figures and described above illustrate but do not limit the invention. Other forms, details, and embodiments may be made and implemented. Therefore, the foregoing description should not be construed to limit the scope of the invention, which is defined in the following claims.

What is claimed is:

1. A calibration surface for an image capture device, the surface comprising glossy areas and matte areas.

2. The surface of claim 1, wherein the surface comprises glossy white areas and matte white areas.

3. The surface of claim 1, wherein the surface comprises a pattern of glossy areas and matte areas.

4. The surface of claim 1, wherein the surface comprises a pattern of glossy white areas and matte white areas.

5. The surface of claim 1, wherein the surface comprises a pattern of alternating glossy areas and matte areas.

6. The surface of claim 5, wherein the pattern comprises a pattern of alternating glossy white areas and matte white areas.

7. The surface of claim 5, wherein the pattern comprises a pattern of alternating glossy areas and matte areas in which each glossy area is surrounded by matte areas and each matte area is surrounded by glossy areas.

8. The surface of claim 7, wherein the pattern comprises a checkerboard pattern of glossy areas and matte areas.

9. The surface of claim 8, wherein the pattern comprises a checkerboard pattern of glossy white areas and matte white areas.

10. A platen for supporting a document or other object to be imaged in an image capture device, the platen comprising a flat surface having glossy areas and matte areas thereon.

11. The platen of claim 10, wherein the surface has a pattern of glossy white areas and matte white areas thereon.

12. The platen of claim 11, wherein the surface has a pattern of alternating glossy white areas and matte white areas thereon.

13. The platen of claim 12, wherein the pattern comprises a pattern of alternating glossy white areas and matte white areas in which each glossy white area is surrounded by matte white areas and each matte white area is surrounded by glossy white areas.

14. The platen of claim 13, wherein the pattern comprises a checkerboard pattern of glossy white areas and matte white areas.

15. An image capture device, comprising:
a platen for supporting a document or other object to be imaged, the platen having a surface with glossy areas and matte areas thereon;
a light for illuminating the platen surface or a document or other object to be imaged on the platen surface;
a camera.

16. The device of claim 15, further comprising a printer and wherein the printer, platen, light and camera are integrated together into a single multi-function image capture and printing device.

17. The device of claim 16, wherein the platen is part of a media input for the printer and the light and camera are mounted to a media output for the printer.

18. The device of claim 16, wherein the platen is mounted atop the printer and the light and camera are mounted to a movable arm, the arm movable between an upright position for imaging the platen surface or objects on the platen surface and a stowed position down, adjacent to the platen.

19. The device of claim 15, wherein the surface has a pattern of alternating glossy white areas and matte white areas thereon.

20. The device of claim 19, wherein the pattern comprises a pattern of alternating glossy white areas and matte white areas in which each glossy white area is surrounded by matte white areas and each matte white area is surrounded by glossy white areas.
